(19) United States
(12) Patent Application Publication
(10) Pub. No.: US 2011/0143732 A1
(43) Pub. Date: Jun. 16, 2011

(54) METHOD AND SYSTEM FOR RECEIVING AND DELIVERING A MEDIA SERVICE

(76) Inventors: Jian YANG, Shenzhen (CN); Guoqiao Chen, Shenzhen (CN); Yuan Bao, Shenzhen (CN); Sichen Wang, Shenzhen (CN)

(21) Appl. No.: 13/026,730

(22) Filed: Feb. 14, 2011

Related U.S. Application Data
(63) Continuation of application No. PCT/CN2009/073268, filed on Aug. 14, 2009.

(30) Foreign Application Priority Data
Aug. 15, 2008 (CN) 200810147429.8

(51) Int. Cl. H04W 4/00

(52) U.S. Cl. 455/414.1

(57) ABSTRACT

A method, an apparatus, a system, User Equipment (UE), and a server for receiving and delivering a media service are disclosed. The method for receiving a media service includes: judging whether a call setup request carries a media service identifier; and receiving media information indicated by the media service identifier if the call setup request carries the media service identifier. At the time of exchanging information, an identifier is carried in the information to indicate the attribute of the media information to be received by the UE, and therefore, the UE can notify the imminent or ongoing service to the user and prepare for receiving the media information according to the attribute of the media information. The identifier also indicates the media service processing capability of the UE, and corresponding operations are performed according to different capabilities of the UE. Therefore, the UE receives the media information that matches its media service processing capability.

### CROSS-REFERENCE TO RELATED APPLICATIONS

This application is a continuation of International Application No. PCT/CN2009/073268, filed on Aug. 14, 2009, which claims priority to Chinese Patent Application No. 200810147429.8, filed on Aug. 15, 2008, both of which are hereby incorporated by reference in their entireties.

### FIELD OF THE INVENTION

The present invention relates to network communications, and in particular, to a method, an apparatus, a system, User Equipment (UE), and a server for receiving and delivering a media service.

### BACKGROUND OF THE INVENTION

Currently, most mobile terminals support Customized Ring Back Tone (CRBT) and Customized Ring Tone (CRT) services. The CRBT service enables a user to customize a ring back tone for the user's mobile terminal according to the preferences and requirements of the user. The ring back tone may be music, an advertisement, or a speech recorded by the user. The CRT service enables a user to customize a ring tone for the user's mobile terminal according to the preferences and requirements of the user. With maturity of 3^{rd} Generation (3G) technologies and products, more 3G networks are deployed and more 3G services are provided around the world. An IP Multimedia Subsystem (IMS) is defined by the 3^{rd} Generation Partnership Project (3GPP) standardization organization in R5 to implement next-generation multimedia telecom services such as audio, video and data.

Currently, the CRBT service is triggered based on only the user's information about subscription to the Customized Multimedia Ringback tone (CMR) service on the server, without considering whether the UE is capable of playing a CMR. The CMR service (such as, the CRBT service or the CRT service) and the Customized Background Tone (CBT) service require different capabilities of the UE. Therefore, in the CMR service in the prior art, different processes cannot be performed according to different capabilities of the UE. In the service processing in the prior art, the UE that receives the service is unable to predict the attribute of the received service or indicate the service attribute to the user.

### SUMMARY OF THE INVENTION

Embodiments of the present invention provide a method, an apparatus, a system, UE, and a server for receiving and delivering a media service. The attribute of the media information to be received by the UE is indicated by an identifier carried in the information during information exchange. Therefore, the UE can notify the user and prepare for receiving the media information according to the attribute of the media information. The identifier can also indicate the capability required for the UE to process the media service. According to different capabilities of the UE, corresponding operations are performed so that the UE can receive the media information matching its capability to process media information.

A method for receiving a media service in an embodiment of the present invention is applied to a customized multimedia ring tone service. The method includes:

judging whether a call setup request carries a media service identifier; and

receiving media information indicated by the media service identifier if the call setup request carries the media service identifier.

A method for delivering a media service in an embodiment of the present invention includes:

receiving a call setup request sent by a calling UE, and obtaining a media service capability identifier carried in the call setup request;

selecting media information that matches a media service processing capability of the calling UE, indicated by the media service capability identifier; and

sending the media information to the calling UE.

An apparatus for receiving a media service in an embodiment of the present invention includes:

a first judging module, configured to judge whether a call setup request carries a media service identifier; and

a first receiving module, configured to receive media information indicated by the media service identifier if the first judging module determines that the call setup request carries the media service identifier.

An apparatus for delivering a media service in an embodiment of the present invention includes:

a second obtaining module, configured to receive a call setup request sent by a calling UE, and obtain a media service capability identifier carried in the call setup request;

a selecting module, configured to select media information that matches a media service processing capability of the calling UE, indicated by the media service capability identifier; and

a sending module, configured to send the media information to the calling UE.

A UE for receiving a media service is provided in an embodiment of the present invention. The UE includes an apparatus for receiving a media service.

A server for delivering a media service is provided in an embodiment of the present invention. The server includes an apparatus for delivering a media service.

A system for transmitting a media service is provided in an embodiment of the present invention. The system includes:

a server, which includes an apparatus for delivering a media service and is configured to receive a call setup request sent by a UE, and obtain a media service capability identifier carried in the call setup request; select media information that matches a media service processing capability of the UE, indicated by the media service capability identifier; and send the media information to the UE; and

the UE, configured to send the call setup request to the server and receive the media information sent by the server.

The embodiments of the present invention obtain a media service identifier carried in a call setup request; parse the media service identifier to obtain the media information attribute indicated by the media service identifier; and display the media information attribute and receive the media information. The carried identifier indicates the type of the media service so that the UE knows the type of the imminent media service and performs operations that match the type of service.

### BRIEF DESCRIPTION OF THE DRAWINGS

To make the technical solution under the present invention or in the prior art clearer, the following describes the accompanying drawings involved in the description of the embodiments of the present invention or the prior art. Apparently, the accompanying drawings outlined below are exemplary only and not exhaustive, and persons of ordinary skill in the art can derive other drawings from such accompanying drawings without any creative effort.

FIG. 1 is a flowchart of a method for receiving a media service in an embodiment of the present invention;

FIG. 2 is a flowchart of a method for delivering a media service in an embodiment of the present invention;

FIG. 3 is a flowchart of a method for delivering a media service such as the CRBT service in an embodiment of the present invention;

FIG. 4 is a flowchart of a method for delivering a media service such as the CRT service in an embodiment of the present invention;

FIG. 5 shows an apparatus for receiving a media service in an embodiment of the present invention;

FIG. 6 shows an apparatus for delivering a media service in an embodiment of the present invention;

FIG. 7 shows a UE for receiving a media service in an embodiment of the present invention;

FIG. 8 shows a server for delivering a media service in an embodiment of the present invention; and

FIG. 9 shows a system for transmitting a media service in an embodiment of the present invention.

### DETAILED DESCRIPTION OF THE EMBODIMENTS

The following detailed description is provided with reference to the accompanying drawings to provide a thorough understanding of the present invention. The drawings and the detailed description are merely representative of particular embodiments of the present invention, and the embodiments are not exhaustive or restrictive. All other embodiments, which can be derived by those skilled in the art from the embodiments given herein without any creative efforts, fall within the scope of the present invention.

The embodiments of the present invention provide a method, an apparatus, a system, UE, and a server for receiving and delivering a media service. A carried identifier indicates the attribute of the media information to be received by the UE; the identifier can also indicate the capability required for the UE to process the media service so that the UE can receive the media information matching its capability to process media information.

The following expounds the method, apparatus, system, UE, and server for receiving and delivering a media service with reference to accompanying drawings and exemplary embodiments.

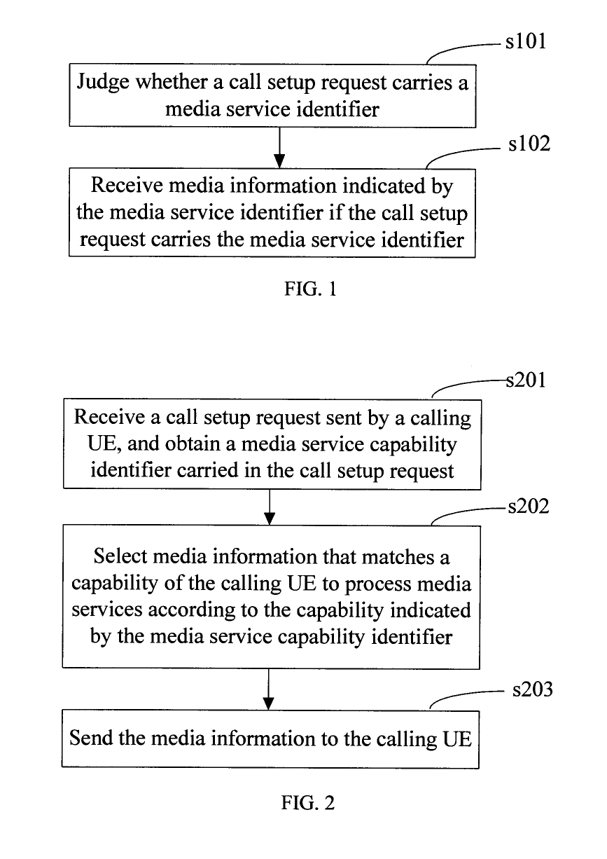

As shown in FIG. 1, a method for receiving a media service in an embodiment of the present invention is applied to a customized multimedia ring tone service and includes the following steps:

Step s101: Judge whether a call setup request carries a media service identifier. Specifically, when sending the call setup request, the calling UE may insert the media service identifier into the request to indicate the attribute of the media information to be played by the calling UE. Alternatively, after the calling UE sends the call setup request to the server, the server inserts the media service identifier into the call setup request.

Step s102: Receive media information indicated by the media service identifier if the call setup request carries the media service identifier; or, reject media information if the call setup request carries no media service identifier. The UE may display the attribute of the media information before or when receiving the media information. For example, if the media information to be played by the calling UE is an audible video CRT, the called UE displays information which indicates that the media information to be played is an audible video CRT, and indicates the type of the current service to the user of the UE; the called UE can shield its own CRT setting, start the external speaker, and receive the CRT information.

Customized multimedia ring tone services include the CRBT service, CRT service, and CBT service. Through the foregoing steps, the called UE can decide whether to receive the media information according to the identifier; and, before receiving the media information, the called UE knows the attribute of the media information and indicates the attribute to the user of the UE, thus preparing for receiving the media information. Before receiving the media information of the calling UE, the called UE may judge whether it is capable of processing the audible video CRT information; if the called UE is capable of processing the audible video CRT information, the called UE receives the audible video CRT information; if the called UE is incapable of processing the audible video CRT information, the called UE does not receive the audible video CRT information, but rings according to the settings on the called UE. The judging process may also be performed by a server. In this way, the case that the UE is not capable of processing the received media information is prevented.

As shown in FIG. 2, a method for delivering a media service in an embodiment of the present invention includes the following steps:

Step s201: Receive a call setup request sent by a calling UE, and obtain a media service capability identifier carried in the call setup request. When the calling UE sends a call setup request to the server on the network, the request carries a media service capability identifier indicating a media service processing capability of the calling UE.

Step s202: Select media information that matches a media service processing capability of the calling UE according to the capability indicated by the media service capability identifier.

If the called UE has subscribed to the media service, the server selects media information among the media service subscription information of the called UE according to the media service processing capability of the calling UE. The selected media information should be media information that can be processed by the calling UE, namely, the media information that matches the media service processing capability of the calling UE. If more than one piece of media information matches the media service processing capability of the calling UE, the server can select any matched media information, or select the media information according to settings of the called UE (for example, the setting of the use time segment).

Step s203: Send the media information to the calling UE.

After sending the media information to the calling UE, the method further includes:

sending session progress information that carries the media attribute identifier to the calling UE so that the calling UE notifies the type of the current service to the user of the UE according to the media information attribute indicated by the media attribute identifier and receives the media information. The notification may be made through texts, speeches, or operation menus, or any combination thereof; and

sending session progress information that carries a media attribute identifier to the calling UE, where the media attribute identifier indicates the attribute of the selected media information; after the server selects the matched media information for the calling UE, using the media attribute identifier to indicate the attribute of the media information, adding the identifier to the session progress information and sending the session progress information to the calling UE so that the calling UE knows the attribute of the media information to be played, and then delivering the media information to the calling UE. Alternatively, the media attribute identifier may be carried in the media information delivered to the calling UE.

It should be noted that, if the call setup request received by the server carries no media service capability identifier, the server determines that the calling UE has low media service processing capabilities, and delivers the media information such as audio information which requires low capabilities of the UE to the UE.

By using the method provided in this embodiment, the server selects the matched media information among the media subscription information of the called UE according to the media service processing capability of the calling UE, and delivers the matched media information to the calling UE, thus preventing failure of playing the media information that requires high capabilities of the UE after such media information is sent to the UE.

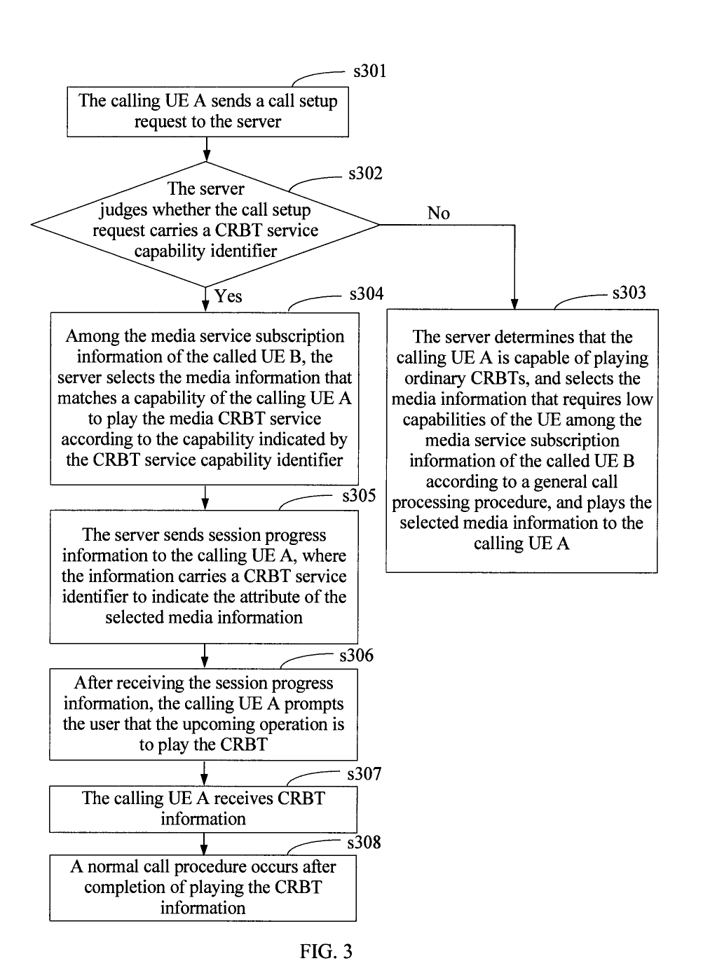

Taking the CRBT service as an example, as shown in FIG. 3, a method for delivering a media service in an embodiment of the present invention includes the following steps:

Step s301: The calling UE A sends a call setup request to the server. If the calling UE A supports the CMR service, the call setup request carries a CRBT service capability identifier. The identifier indicates that the calling UE A is capable of processing media CRBT services, and indicates specific types of CRBT services that can be processed by UE A.

Step s302: After receiving the call setup request, the server judges whether the call setup request carries a CRBT service capability identifier. If the called UE B has subscribed to the media CRBT service, but the call setup request carries no CRBT service capability identifier, perform step s303; if the call setup request carries the CRBT service capability identifier, perform step s304.

Step s303: The server determines that the calling UE A is capable of playing ordinary CRBTs, and obtains the media information (such as an audio CRBT) that requires low capabilities of the UE among the media service subscription information of the called UE B according to a general call processing procedure, and plays the selected media information to the calling UE A.

Step s304: Among the media service subscription information of the called UE B, the server selects the media information that matches a capability of the calling UE A to play the media CRBT service, according to the capability indicated by the CRBT service capability identifier.

Specifically, the CRBT service capability identifier indicates the types of media information that can be processed by the calling UE A, and the server selects the matched media information among the media service subscription information of the called UE according to the attribute of the media information indicated by the CRBT service capability identifier. For example, if the CRBT service capability identifier indicates that the calling UE A is capable of playing a video CRBT, the server selects the video CRBT among the media service subscription information of the called UE; or selects a CRBT type that requires lower capability of the UE.

Step s305: The server sends session progress information to the calling UE A, where the information carries a CRBT service identifier to indicate the attribute of the selected media information.

Step s306: After receiving the session progress information, the calling UE A notifies the user that the imminent operation is to play the CRBT. The notification may be made of texts, speeches, or different colors, or any combination thereof; or an operation menu is offered to the user for stopping, pausing or copying the CRBT. At the time of notifying the user, the timing for the current call may be cancelled, and the timing starts again after completion of playing the CRBT. Meanwhile, the corresponding operation may be performed according to the attribute of the media information. If the media information is audio information, the volume of the UE may be adjusted according to the volume of the audio information.

Step s307: The calling UE A receives the CRBT information sent by the network. The operation of notifying the user in step s306 may also be performed when the CMR information is received from the network.

Step s308: A normal call procedure occurs after completion of playing the CRBT information. If the automatic call timing function is disabled in the preceding step, the automatic call timing function needs to be enabled in this step.

If the call setup request sent by the calling UE carries no CRBT service capability identifier, the calling UE is treated as a UE that has ordinary capabilities, and the media CRBT that requires low capabilities of the UE (such as an audio CRBT) is played to the UE, thus accomplishing compatibility of the UE. If the call setup request carries this identifier, proper diverse CMRs can be provided for the calling UE according to the service capability indicated by the identifier.

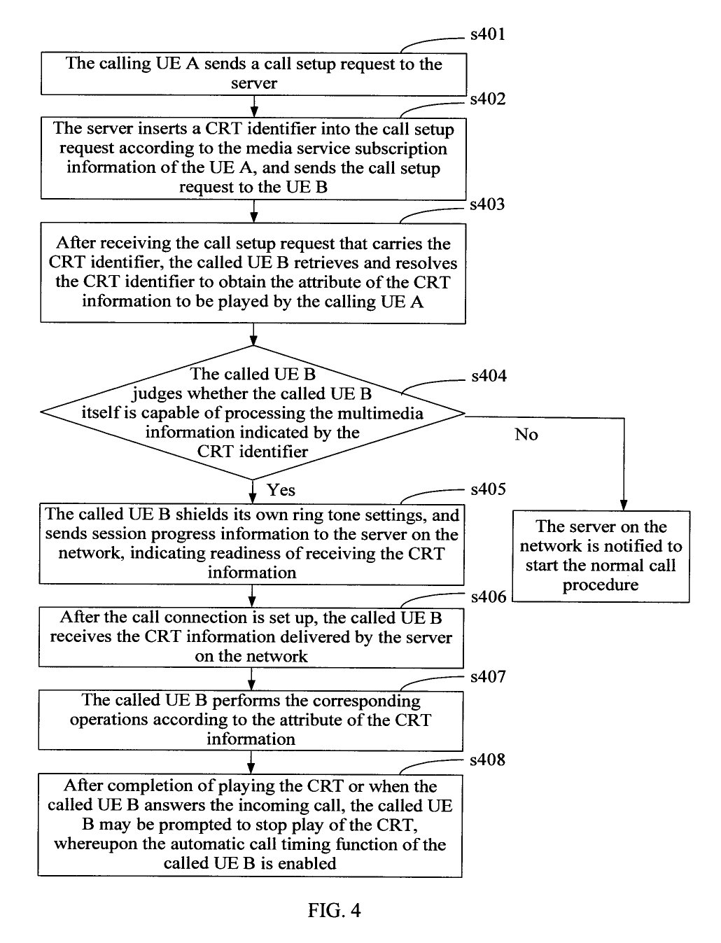

Taking the CRT service as an example, as shown in FIG. 4, a method for delivering a media service in an embodiment of the present invention includes the following steps:

Step s401: The calling UE A sends a call setup request to the server.

Step s402: The server inserts a CRT identifier into the call setup request according to the media service subscription information of the UE A, and sends the call setup request to the UE B. The CRT identifier may also be inserted at the calling UE A directly, tells the called UE B about the imminent or ongoing CRT service, and indicates the attribute of the media information to be received by the called UE B.

Step s403: After receiving the call setup request that carries the CRT identifier, the called UE B retrieves and parses the CRT identifier to obtain the attribute of the CRT information to be played by the calling UE A. Specifically, after it is determined that the request carries the CRT identifier, the called UE B receives the CRT information; if it is determined that the request carries no CRT identifier, the called UE B rejects CRT information.

Step s404: The called UE B judges whether the called UE B itself is capable of processing the CRT information. If the called UE B itself is capable of processing the CRT information, the called UE B notifies the server on the network to start a non-normal call CRT procedure, and performs step s405; if the called UE B itself is incapable of processing the CRT information, the called UE B notifies the server on the network to start a normal call procedure. The judging process may also be performed by the server.

Step s405: The called UE B shields its own ring tone settings, and sends session progress information to the server on the network, indicating readiness of receiving the CRT information.

Step s406: After the call connection is set up, the called UE B receives the CRT information delivered by the server on the network.

Step s407: The called UE B performs the corresponding operations according to the attribute of the CRT information. For example, if the CRT information is multimedia audio information, it is necessary to start the external speaker of the called UE B to play the multimedia audio information; if the CRT information attribute carries information about the required volume, it is necessary to adjust the volume of the UE according to the volume requirement; or, information may pop up to notify the user of the called UE B that the CRT of the calling UE A is being played currently; or, an operation menu may pop up to control the progress of playing the multimedia information (such as stopping play, pausing play, or answering an incoming call).

Step s408: After completion of playing the CRT or when the called UE B answers the incoming call, the called UE B may be notified to stop play of the CRT, whereupon the automatic call timing function of the called UE B is enabled.

In step s404 above, if the called UE B is incapable of processing media information indicated by the CRT identifier, the called UE B is treated as a UE that has inferior capabilities, a normal call procedure occurs, and the CRT set by the user is played on the called UE B. The CRT identifier carries one or more attributes of the media information. If the CRT identifier carries multiple attributes of the media information, the called UE B may judge the attributes of the media information one by one.

The operations in step s407 above may also be performed in step s405. Namely, the attribute of the received media information is notified to the user of the UE before the media information is received.

When the media service identifier, media service capability identifier, and media attribute identifier mentioned in the foregoing embodiment are carried in the call setup request or other information, the identifiers are primarily carried through an IMS Communication Service Identifier (ICSI), a Session Description Protocol (SDP), or an Extensible Markup Language (XML) file. In the practical information interaction process, the method for carrying the identifiers is not limited to the three methods above, and the three methods given above serve as preferred examples only.

Mode 1: The identifiers are carried through an ICSI, and more specifically, the Accept-Contact header field is extended to carry the identifiers. In the Session Initiation Protocol (SIP), the Accept-Contact header field may identify the reference information of the UE; the indication information of the CMR services (including the CRBT service, CRT service, and CBT service) in this header field may be set to “+g.3gpp.CMR”. To express more detailed information, a feature tag may be defined, or attributes are added, for example, “+g.3gpp.CMR”, and “SubAPPName=VALUE”, where the SubAPPName represents the sub-application name (sub-service name), and its value and the corresponding sub-application are shown in Table 1:

TABLE 1

| SubAPPName value | Corresponding Sub-Application |
|---|---|
| * | Not depending on sub-application |
| CBT | Customized Background Tone |
| CRT | Customized Ring Tone |
| CRBT | Customized Ring Back Tone |

According to the table above, the service type can be indicated by identifiers in the following ways:

1. “P-Preferred-Service:urn:urn-xxx.cmr” is defined to indicate that the current service is a CMR service; and then “APPLICATION” defines its sub-application. The following is an example:

+g.ims.app_ref=“<urn: urn-xxx.cmr:3gpp.application.crbt>” indicates that the current service is a CRBT service among the CMR services;

+g.ims.app_ref=“<urn: urn-xxx.cmr:3gpp.application.crt>” indicates that the current service is a CRT service among the CMR services;

+g.ims.app_ref=“<urn: urn-xxx.cmr:3gpp.application.cat>” indicates that the current service is a Customized Alerting Tone (CAT) service among the CMR services; and

+g.ims.app_ref=“<urn: urn-xxx.cmr:3gpp.application.CRS>” indicates that the current service is a Customized Ring Signal (CRS) service among the CMR services.

In the foregoing example, both the CRBT service and the CAT service are two types of CRBT service using different protocols, and the CRT service and the CRS service are two types of CRT service.

The attribute information at the time of playing the media information may be added at the end of the foregoing implementation mode, for example, volume information at the time of playing audio information; full-screen display or non-full-screen display at the time of playing video information; or attribute information such as the font at the time of displaying texts.

On the basis of the foregoing examples, the sub-application expression mode may be extended. Take the CRBT service as an example: “3gpp.application.crbt.text” indicates a text CRBT; “3gpp.application.crbt.audio” indicates an audio CRBT; “3gpp.application.crbt.video” indicates a video CRBT; and “3gpp.application.crbt.audio&text” and “3gpp.application.crbt.video&text” indicate a CRBT of multiple applications.

When the call setup request carries a CMR identifier, the following header field may be carried to indicate the media service capability of the calling UE:

Accept-Contact: +g.ims.app_ref=“<urn: urn-xxx.cmr:3gpp.application.crbt.audio>

P-Preferred-Service: urn:urn-xxx.cmr

The foregoing header field indicates that the calling UE that currently originates the service call is capable of the CRBT service in the CMR services, and more specifically, capable of the audio function in the CRBT service.

If the information carried in the header field is:

Accept-Contact: +g.ims.app_ref=“<urn: urn-xxx.crt:3gpp.application.crt.audio>

P-Preferred-Service: urn:urn-xxx.cmr

it indicates that the called UE needs to perform the audio CRT service when the called UE knows that the current call is a CRT service in the CMR services.

2. Alternatively, “P-Preferred-Service:urn:urn-xxx.crbt” is defined to indicate that the current service is a specific sub-application of the CMR service. The specific definitions may be as follows:

urn:urn-xxx.crbt represents a CRBT service;

urn:urn-xxx.crt represents a CRT service;

urn:urn-xxx.cat represents a CAT service; and

urn:urn-xxx.crs represents a CRS service.

The extension of the service definition mode is the same as that in “1” above.

For example, the following header field is added to the call setup request to carry the identifier:

Accept-Contact: +g.ims.app_ref=“<urn:urn-xxx.crbt:3gpp.application.crbt.audio>

P-Preferred-Service: urn:urn-xxx.crbt

The foregoing header field indicates that the calling UE that currently originates the call setup request is capable of performing the CRBT service, and more specifically, capable of the audio function of the CRBT service.

The following is another example:

Accept-Contact: +g.ims.app_ref=“<urn:urn-xxx.crt:3gpp.application.crt.audio.v50%>

P-Preferred-Service: urn:urn-xxx.crt

The foregoing header field indicates that, the called UE needs to perform the audio CRT service operation when the called UE knows that the current call is a CRT service application, and the audio volume is controlled within 50%.

Mode 2: The SDP protocol is extended to carry the identifiers:

Primarily, the “A” attribute is used to carry the CMR identifier in the SDP protocol. This mode includes the following two methods:

Method 1: The attribute in the “A=Attribute:value” part in the SDP protocol is extended.

Two definition methods are applicable:

Definition method 1: The attribute in the “A=Attribute:value” part in the SDP protocol is extended, and the format is defined as “A=FeatureTag:3gpp.application.ServiceAPP.subAPP.CAP”, which indicates the service type and the service style. In the case of the CRBT service, the extended attribute indicates the service capability of the calling UE; in the case of the CBT service, the call setup request received by the called UE carries the identifier, and this identifier indicates the service capability of the calling UE.

“ServiceAPP” indicates the current service, and its value may be “CMR” indicating that the current service is a CMR service.

“subAPP” indicates the current sub-application, and its value may be “CRBT”, “CRT”, “CBT”, “CAT”, or “CRS”.

CAP indicates the current service style, and its value may be “audio” (audio service), “video” (video service), “text” (text service), or “*” (all services). Multiple service styles may coexist. When multiple service styles coexist, the service styles are not logically contradictory.

When this method is used to indicate that the current service of the calling UE is the CRBT service among the CMR services and that the service styles are Video and Text, the identifier may be carried in the following mode:

A=FeatureTag: 3gpp.application.CMR.CRBT.Video&Text

When this method is used to indicate that the current service of the calling UE is the CBT service among the CMR services and that the service style is Video, the identifier may be carried in the following mode:

A=FeatureTag: 3gpp.application.CMR.CBT.Video

When the call setup request of the calling UE passes through the server, the server inserts the foregoing identifier into the call setup request according to the CBT service subscription information, and then sends the call setup request to the called UE. The identifier indicates that the current service is a CBT service application in the CMR service, and that the current CBT is of the video style. In this way, after receiving the identifier, the called UE connects the data receiving channel, and plays the CBT by using the multimedia setting of the CRT.

Definition method 2: The attribute in the “A=Attribute:value” part in the SDP protocol is extended, and the format is defined as “3gpp.application.subAPP.CAP”, where subAPP indicates CRBT, CRT, or CRBT; and CAP indicates audio, video, or text. Different from definition method 1, this method does not require a ServiceAPP field.

Method 2: The identifier is carried in the “A” attribute descriptive of media information.

The following description takes the CRBT service as an example:

v=0

o=−424 3292855200 IN IP6 FF15:0:0:0:0:0:81:1BC

s=Call session with CRBT

c=IN IP6 FF15:0:0:0:0:0:81:1BD

t=0 0

m=video 9004 RTP/AVP 98

a=rtpmap:98 CRBT/90000

a=fmtp:98 contains-redundant=“redundant”

In the foregoing “A” attribute descriptive of the media information, an “a=rtpmap:98 CRBT/90000” field is added to identify the service information of the UE.

Mode 3: An XML file carries the CRBT service identifier.

The data structure is defined below:

<!-- edited with XMLSpy v2008 rel. 2 spl (http://www.altova.com)

by 3ddown.com (no) -->

<!ELEMENT CMR EMPTY>
<!ATTLIST CMR

CMR_Service CDATA #REQUIRED
MutiMediaCAP CDATA #IMPLIED

>
<!--CMR_Service indicates whether the current service is CRBT,

CRT, CBT, CAT, CMR, or CSR-->

<!—MutiMediaCAP indicates the required media type of the CRBT

service, namely, Audio, Video, or Text-->

### Example 1

The following indicates that the current UE supports the CRBT service, and that the service styles of the CRBT are Video and Text:

<?xml version=“1.0” encoding=“UTF-8”?>
<!DOCTYPE CMR SYSTEM “ \CMR.dtd”>
<CMR CMR_Service=“CRBT” MutiMediaCAP=“Video&Text”/>

### Example 2

The following indicates that the current call is a CRT service, and that the service style of the CRBT is Video:

<?xml version=“1.0” encoding=“UTF-8”?>
<!DOCTYPE CMR SYSTEM “ \CMR.dtd”>
<CMR CMR_Service=“CRT” MutiMediaCAP=“Video ”/>

When a SIP or Hypertext Transfer Protocol (HTTP) carries this file, the file may be carried by means of a multipart type, or carried directly. Alternatively, MIME TYPE may be constructed to indicate the nature of the file, for example, if MIMETYPE is Application/CMR, it indicates that the file is a CRBT service presentation file.

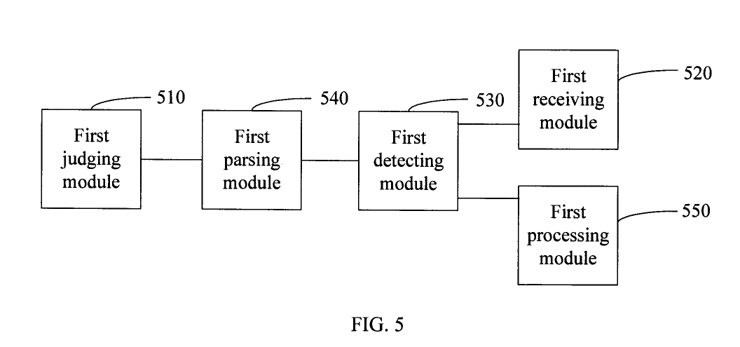

To implement the method above, an apparatus for receiving a media service is provided in an embodiment of the present invention. As shown in FIG. 5, the apparatus includes: a first judging module 510, configured to judge whether a call setup request carries a media service identifier; and a first receiving module 520, configured to receive media information indicated by the media service identifier if the first judging module 510 determines that the call setup request carries the media service identifier.

The apparatus further includes: a first detecting module 530, which is configured to detect whether the UE is capable of processing the media information. The first receiving module 520 is specifically configured to receive media information indicated by the media service identifier if the first detecting module 530 detects that the UE is capable of processing the media information and the first judging module 510 determines that the call setup request carries the media service identifier.

The apparatus further includes: a first parsing module 540, configured to parse the media service identifier and obtain the attribute of the media information indicated by the media service identifier; and a first processing module 550, configured to display the attribute of the media information.

The first processing module 550 is further configured to: shield the settings of the UE and/or start the external speaker for playing the received media information before or when receiving the media information according to the attribute of the media information; and/or pop up information to notify the user of the format of the media information to be played or being played currently; and/or display an operation menu to control the progress of playing the media information.

The foregoing apparatus uses a processing module to display the attribute of the media information on the UE. Therefore, the UE can notify the user of the imminent or ongoing service, prepare for receiving the media information according to the attribute of the media information, and receive the media information.

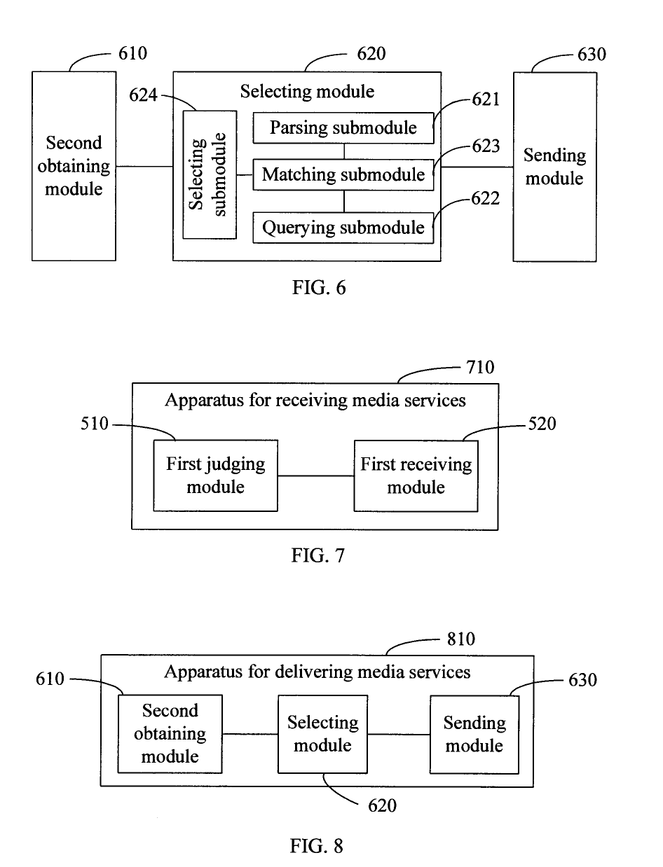

As shown in FIG. 6, an apparatus for delivering a media service in an embodiment of the present invention includes:

a second obtaining module 610, configured to receive a call setup request sent by a calling UE, and obtain a media service capability identifier carried in the call setup request;

a selecting module 620, configured to select media information that matches a media service processing capability of the calling UE according to the capability indicated by the media service capability identifier; and

a sending module 630, configured to send the media information to the calling UE.

The sending module 630 is further configured to send session progress information that carries the media attribute identifier to the calling UE so that the calling UE notifies the type of the current service to the user of the UE according to the media information attribute indicated by the media attribute identifier and receives the media information. The notification may be made of texts, speeches, or operation menus, or any combination thereof.

The selecting module 620 includes:

a parsing sub-module 621, configured to parse the media service capability identifier obtained by the second obtaining module 610 to obtain the media service processing capability of the calling UE;

a querying sub-module 622, configured to query the attribute of the media information in the media service subscription information of the called UE;

a matching sub-module 623, configured to match the media service processing capability of the calling UE with the attribute of the media information, where the capability is obtained by the parsing sub-module and the attribute is found by the querying sub-module 622; and

a selecting sub-module 624, configured to select any piece of media information among the matched media information when the matching sub-module 623 obtains more than one piece of matched media information.

Through the foregoing modules, the server can select proper media information for playing according to the capability of the UE to process media information, thus preventing failure of playing the received media information that goes beyond the capability of the UE.

A UE for receiving a media service is provided in an embodiment of the present invention. As shown in FIG. 7, the UE includes an apparatus 710 for receiving a media service. The apparatus 710 for receiving a media service includes: a first judging module 510, configured to judge whether a call setup request carries a media service identifier; and a first receiving module 520, configured to receive media information indicated by the media service identifier if the first judging module 510 determines that the call setup request carries the media service identifier.

The apparatus further includes a first detecting module, which is configured to detect whether the UE is capable of processing the media information. The first receiving module 520 is specifically configured to receive media information indicated by the media service identifier if the first detecting module detects that the UE is capable of processing the media information and the first judging module 510 determines that the call setup request carries the media service identifier.

The apparatus further includes: a first parsing module, configured to parse the media service identifier and obtain the attribute of the media information indicated by the media service identifier; and a first processing module, configured to display the attribute of the media information.

The first processing module is further configured to: shield the settings of the UE and/or start the external speaker for playing the received media information before or when receiving the media information according to the attribute of the media information; and/or pop up information to notify the user of the format of the media information to be played or being played currently; and/or display an operation menu to control the progress of playing the media information.

A server for delivering a media service is provided in an embodiment of the present invention. As shown in FIG. 8, the server includes an apparatus 810 for delivering a media service. The apparatus 810 for delivering a media service includes:

a second obtaining module 610, configured to receive a call setup request sent by a calling UE, and obtain a media service capability identifier carried in the call setup request;

a selecting module 620, configured to select media information that matches a media service processing capability of the calling UE according to the capability indicated by the media service capability identifier; and

a sending module 630, configured to send the media information to the calling UE.

The sending module 630 is further configured to send session progress information that carries the media attribute identifier to the calling UE so that the calling UE notifies the type of the current service to the user of the UE according to the media information attribute indicated by the media attribute identifier and receives the media information. The notification may be made of texts, speeches, or operation menus, or any combination thereof.

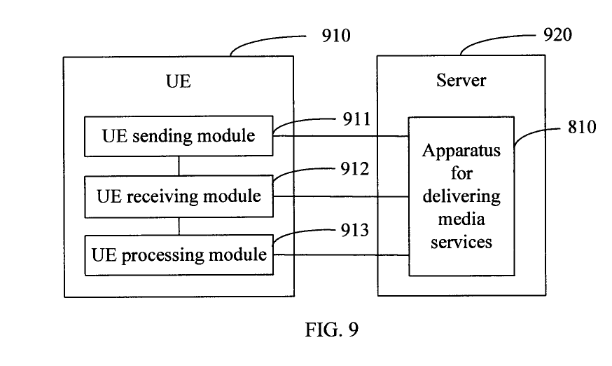

A system for transmitting a media service is provided in an embodiment of the present invention. As shown in FIG. 9, the system includes:

a server 920, which includes an apparatus 810 for delivering a media service and is configured to: receive a call setup request sent by a UE, and obtain a media service capability identifier carried in the call setup request; select media information that matches a media service processing capability of the UE according to the capability indicated by the media service capability identifier; and send the media information to the UE; and

a UE 910, configured to send the call setup request to the server 920 and receive the session progress information and media information sent by the server 920. The UE 910 includes:

a UE sending module 911, configured to send a call setup request that carries a media service capability identifier to the server 920;

a UE receiving module 912, configured to receive the media information sent by the server 920; and

a UE processing module 913, configured to notify the type of the current service and receive the media information to the user of the UE according to the media information attribute indicated by the media attribute identifier after the UE receiving module 912 receives the session progress information that carries the media attribute identifier, where the notification may be made of texts, speeches, or operation menus, or any combination thereof.

The UE processing module 913 is further configured to notify the attribute of the media information indicated by the media attribute identifier to the user of the UE. The UE processing module provides the notification through texts, speeches, colors, operation menus, or any combination thereof. The call timing function is disabled at the time of notifying, and is enabled again after completion of playing the media information.

By using the method provided in this embodiment, the UE obtains a media service identifier carried in a call setup request; parses the media service identifier to obtain the media information attribute indicated by the media service identifier; and displays the media information attribute and receives the media information. The carried identifier indicates the type of the media service so that the UE knows the type of the imminent media service and performs operations that match this type. Meanwhile, the server receives the call setup request, and obtains the media service capability identifier carried in the call setup request; selects media information that matches a media service processing capability of the calling UE according to the capability indicated by the media service capability identifier; and sends the session progress information that carries the media attribute identifier to the calling UE, where the media attribute identifier indicates the attribute of the selected media information. Therefore, the server delivers the matched media information according to the capability of the UE, and overcomes incompatibility between the media information and the UE capability.

After reading the foregoing embodiments, those skilled in the art are clearly aware that the present invention may be implemented through hardware, or through software in addition to a necessary universal hardware platform. Therefore, the technical solution under the present invention may be embodied as a software product. The software product may be stored in a non-volatile storage medium (such as a Compact Disk-Read Only Memory (CD-ROM), a Universal Serial Bus (USB) flash disk, or a mobile hard disk), and may include several instructions that enable a computer device (such as a personal computer, a server, or a network device) to perform the methods provided in the embodiments of the present invention.

The above descriptions are merely exemplary embodiments of the present invention, but not intended to limit the scope of the present invention. Any modifications or variations that can be derived by those skilled in the art shall fall within the scope of the present invention.

What is claimed is:

1. A method for receiving a media service, applied to a customized multimedia ring tone service, comprising:
judging whether a call setup request carries a media service identifier; and
receiving media information indicated by the media service identifier if the call setup request carries the media service identifier.

2. The method according to claim 1, further comprising:
rejecting the media information if determining that the call setup request carries no media service identifier.

3. The method according to claim 1, wherein after the determining that the call setup request carries the media service identifier and before receiving the media information indicated by the media service identifier, the method further comprises:
determining that User Equipment (UE) is capable of processing the media information indicated by the media service identifier.

4. The method according to claim 1, wherein after the determining that the call setup request carries the media service identifier, the method further comprises:
parsing the media service identifier, obtaining an attribute of the media information indicated by the media service identifier, and displaying the attribute of the media information.

5. The method according to claim 4, comprising:
shielding ring tone settings of User Equipment (UE) and starting an external speaker when displaying the attribute of the media information, if the media service identifier is a Customized Ring Tone (CRT) service identifier.

6. The method according to claim 1, wherein the media service identifier is one of:
a media service identifier inserted by calling User Equipment (UE) into the call setup request; and
a media service identifier inserted by a server into the call setup request after receiving the call setup request of the calling UE.

7. A method for delivering a media service, comprising:
receiving a call setup request sent by calling User Equipment (UE), and obtaining a media service capability identifier carried in the call setup request;
selecting media information that matches a media service processing capability of the calling UE, indicated by the media service capability identifier; and
sending the media information to the calling UE.

8. The method according to claim 7, wherein after the sending the media information to the calling UE, the method further comprises:
sending session progress information that carries a media attribute identifier to the calling UE to enable the calling UE to notify the type of a current service to a user of the calling UE according to a media information attribute indicated by the media attribute identifier and to receive the media information, wherein the user is notified by at least one of the flowing means: text, speech, and operation menus, or any combination of them.

9. The method according to claim 8, comprising:
disabling a call timing function when notifying the type of the current service to the user of the calling UE, and enabling the call timing function again after completion of playing the media information.

10. The method according to claim 7, wherein the step of selecting the media information that matches the media service processing capability of the calling UE, indicated by the media service capability identifier comprises:
matching the media service processing capability of the calling UE with each attribute of the media information in media service subscription information of called UE, and determining the media information as matched if the calling UE capability required by the media information is not higher than the media service processing capability of the calling UE; and
selecting any piece of media information among the matched media information if more than one piece of media information matches the media service processing capability of the calling UE.

11. The method according to claim 8, wherein:
the attribute of the media information is at least one of
type, format, size, transmission rate, image pixel of the media information, and any combination thereof.

12. The method according to claim 7, wherein:
the identifier is carried through an IP Multimedia Subsystem Communication Service Identifier (ICSI), or a Session Description Protocol (SDP) or an Extensible Markup Language (XML) file.

13. User Equipment (LTE) for receiving a media service, comprising:
a first judging module, configured to judge whether a call setup request carries a media service identifier; and
a first receiving module, configured to receive media information indicated by the media service identifier if the first judging module determines that the call setup request carries the media service identifier.

14. The UE according to claim 13, further comprising:
a first detecting module,
configured to detect whether the UE is capable of processing the media information;
wherein, the first receiving module is specifically configured to receive the media information indicated by the media service identifier if the first detecting module detects that the UE is capable of processing the media information and the first judging module determines that the call setup request carries the media service identifier.

15. The UE according to claim 13, further comprising:
a first parsing module, configured to parse the media service identifier and obtain an attribute of the media information indicated by the media service identifier; and
a first processing module, configured to display the attribute of the media information.

16. A server for delivering a media service, comprising:
a second obtaining module, configured to receive a call setup request sent by calling User Equipment (UE), and obtain a media service capability identifier carried in the call setup request;
a selecting module, configured to select media information that matches a media service processing capability of the calling UE, indicated by the media service capability identifier; and
a sending module, configured to send the media information to the calling UE.

17. The server according to claim 16, wherein:
the sending module is further configured to send session progress information that carries a media attribute identifier to the calling UE, to enable the calling UE to notify the type of a current service to a user of the UE according to a media information attribute indicated by the media attribute identifier and to receive the media information, wherein the user is notified by at least one of the flowing means: text, speech, and operation menus, or any combination of them.

18. The server according to claim 16, wherein the selecting module comprises:
a parsing sub-module, configured to parse the media service capability identifier obtained by the second obtaining module to obtain the media service processing capability of the calling UE;
a querying sub-module, configured to query an attribute of the media information in media service subscription information of a called UE;
a matching sub-module, configured to match the media service processing capability of the calling UE with the attribute of the media information; and
a selecting sub-module, configured to select any piece of media information among matched media information if the matching sub-module obtains more than one piece of matched media information.
